(19) United States
(12) Patent Application Publication
(10) Pub. No.: US 2008/0289511 A1
(43) Pub. Date: Nov. 27, 2008

(54) Combination grilling basket and tool set

(76) Inventor: Jose R. Mendez, Columbus, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/805,137

(22) Filed: May 22, 2007

(51) Int. Cl. A47J 36/20

(52) U.S. Cl. 99/357

(57) ABSTRACT

A combination cooking basket and cooking tool holder having an upper and lower basket securable together to form an enclosure, and a cooking tool or tools releasable fastened in the enclosure for storage and washing as a unit, the components being separable for use while cooking.

### TECHNICAL FIELD

Basket and cooking tools used in cooking and particularly grilling on a barbecue grill.

### BACKGROUND OF THE INVENTION

Cooking on a barbecue grill enjoys widespread popularity. Barbecue grills are available with fuel sources ranging from gas to charcoal, to electric elements, and includes smoker grills in which the food is cooked by a combination of heat and smoke and not directly over an open flame or a hot bed of charcoals. Barbecue grill sizes range from small table top grills to very large grills that are the centerpiece of outdoor kitchens. In addition, many restaurants have developed grilling sections in indoor facilities, utilizing a flame hood and exhaust fans to exhaust the smoke produced to the outside of the building. Another popular method of cooking is over an open campfire while on camping trips or the like.

In any of the above-mentioned environments, the most important element of the cooking process, after the food and the grill itself, are the tools used to manipulate the food on the cooking grate. With most grills, the food is cooked one side at a time, the first side being disposed over the heat source for a specified period of time, after which the food is turned over to cook the opposite side. The method typically involves searing the food on each side to seal the perimeter of the food while keeping the juices inside. Keeping the juices inside the food in this manner results in the food being moist inside when it has finished cooking. One key to this method is the minimal piercing or penetration of the food by sharp objects, which would result in the natural juices of the meat escaping and causing the end product to be somewhat dry. Thus, the most popular grilling tools tend to be spatulas, tongs, and a long handled fork for aiding in picking up the food with the spatula or grasping it with the tongs.

Another popular component used during grilling is a basket that, when configured with a top and bottom, can be used to flip food during cooking or into which smaller pieces of food can be placed and grilled over an open flame or other heat source. Such baskets are constructed from a wide variety of material and come in many shapes and sizes. There are baskets available that are designed and sized to cook, for example, whole fish, hamburgers, shrimp and other small fish or meats, vegetables, fruits, etc. One common feature of grill baskets is that they typically are relatively flat on each side so that they can be easily situated on a cooking grate. The baskets are also normally provided with four walls to keep food contained therein, and a depth of no more than a few inches to maintain the food in relatively close proximity to the heat source.

While grilling is and will likely remain a popular activity, the cleaning of the grilling implements is far less popular and can be troublesome. The implements, whether baskets, or grilling tools, typically become greasy during the cooking process and can also be soiled by the other necessary by-products of such cooking, namely charred food bits, ash, etc. Grilling tools, which are normally provided with relatively long handles to keep the user's hand away from the heat source, are difficult to clean either by hand or in a dishwasher due to their unwieldy length and design. It is to some of these deficiencies that the present disclosure is aimed as there is a need not addressed by any known prior art either alone or in combination.

### SUMMARY

A combination cooking basket and tool holder is disclosed in which at least one basket and tool are provided for use in cooking and are releasably securable to one another for cleaning and storage. Another embodiment employs a second basket to form an enclosure around the tool or tools, both baskets being usable for cooking either alone or in combination.

### BRIEF DESCRIPTION OF THE DRAWINGS

FIG. 1 is a perspective view illustrating a combination cooking basket and tool holder;

FIG. 2 is an exploded perspective view with the upper half of the basket removed;

FIG. 2B is a partial perspective view of the distal end of the tool receiving basket; and

FIG. 3 is partial perspective view showing the basket disposed on a barbecue grill and being used for cooking.

### DETAILED DESCRIPTION

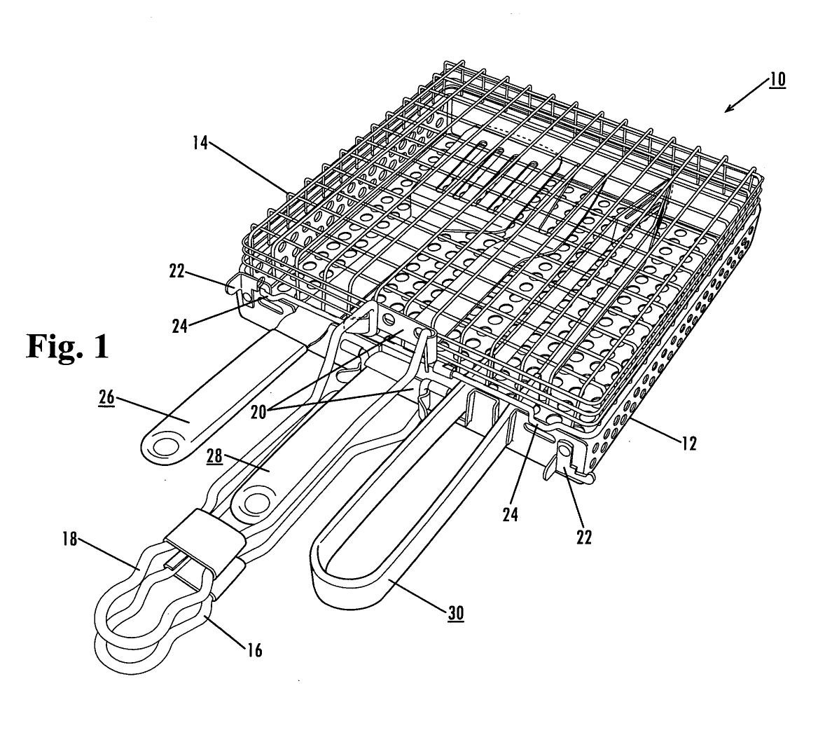

Referring now more specifically to the drawings and to FIG. 1 in particular, numeral 10 designates generally the combination cooking basket and tool holder. As shown in FIG. 1, the unit is configured both for storage when not in use and also for placement into a dishwasher or the like for cleaning purposes after it has been used in cooking. The unit includes a lower basket 12 and an upper basket 14, the lower basket being formed of a perforated metal and the upper basket being formed from wire. It will be understood by those of ordinary skill in the art that many different configurations for the upper and lower basket are possible. For example, while illustrated as rectangular, many other shapes are possible and contemplated by the instant disclosure. In addition, the baskets can be made entirely of perforated metal, entirely of wire, entirely of mesh, or any other material that is capable of withstanding the heat produced by a cooking appliance or open flame, and/or a dishwasher. Similarly, the upper and lower baskets can be produced with any combination of materials suitable for use in cooking and in containing the tools before and after use. While metals are normally the material of choice for the baskets, any of a number of heat resistant materials that can be formed into the general shape of a basket may also be used.

The lower and upper baskets, 12 and 14 respectively, are also each supplied with a handle 16 for the lower basket and handle 18 for the upper basket. The handles are mounted to the baskets by means of brackets 20, which are designed to removably receive the handles. The distal ends of the baskets are interfaced either with a press fit, a tongue and slot arrangement (not shown), or other securing means. The right and left sides of the baskets are designed to interface in such a way as to form, in effect, a “sealed” enclosure, while the proximal end is secured by means of securing means such as rotatable clasps 22 that engage hooks 24 formed in the upper basket. As shown in FIG. 1, the clasp on the left side is rotated into a securing position while the clasp on the right side is rotated into a position whereby the baskets can be separated.

Disposed within the basket, as shown in FIG. 1, are three common cooking tools. While the description from this point forward focuses on these particular tools, it will be understood by those of ordinary skill in the art that various other tools may be employed and the baskets can be suitably configured to receive tools other than those shown here. The tools illustrated in FIG. 1 and throughout the present application are those typically most widely used in cooking, namely a spatula 26, a fork 28, and a pair of tongs 30.

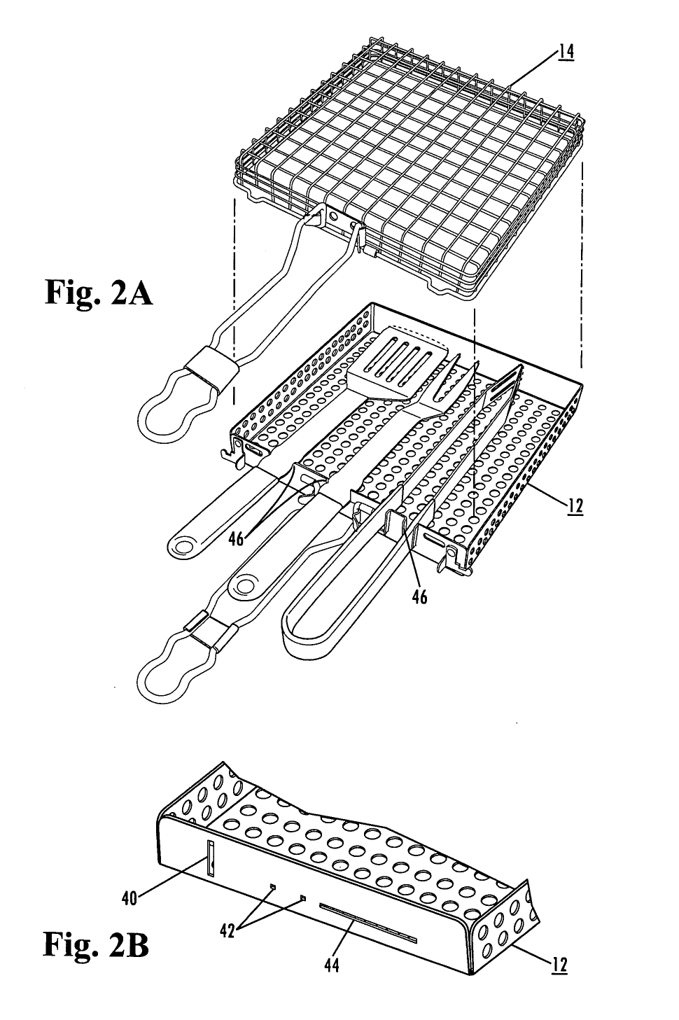

Referring now to FIGS. 2A and 2B, FIG. 2A illustrates the combination cooking basket and tool holder with the upper basket separated from the lower basket. As shown, the clasps 22 have both been rotated to an open position so that the upper basket can be lifted off of the lower basket. FIG. 2B illustrates the distal end of the lower basket, which is provided with a vertical slot 40, which is designed to receive the distal ends of the tongs 30, apertures 42, designed to receive the tines of the fork 28, and a horizontal slot 44, which is designed to receive the distal end of the spatula 26. The proximal end of the lower basket is provided with recesses, collectively referred to by numeral 46, which are designed to receive the shafts of the tools. Two recesses are provided for receiving the opposing legs of the tongs while a single recess is provided for each of the shafts of the fork and spatula. These recesses, as well as the slots 40 and 44 and the apertures 42 on the distal end of the basket, collectively referred to as fastening means, can be varied to the particular style, shape, or other dimensions of the tools that are to be placed therein. Recesses 46 are designed to provide a relatively close fit between the walls of the recesses and the shafts of the tools that are disposed therein, which, in combination with the slots and apertures on the distal end cooperate to provide a relatively snug fit, thereby keeping the tools in place during periods of washing and/or storage.

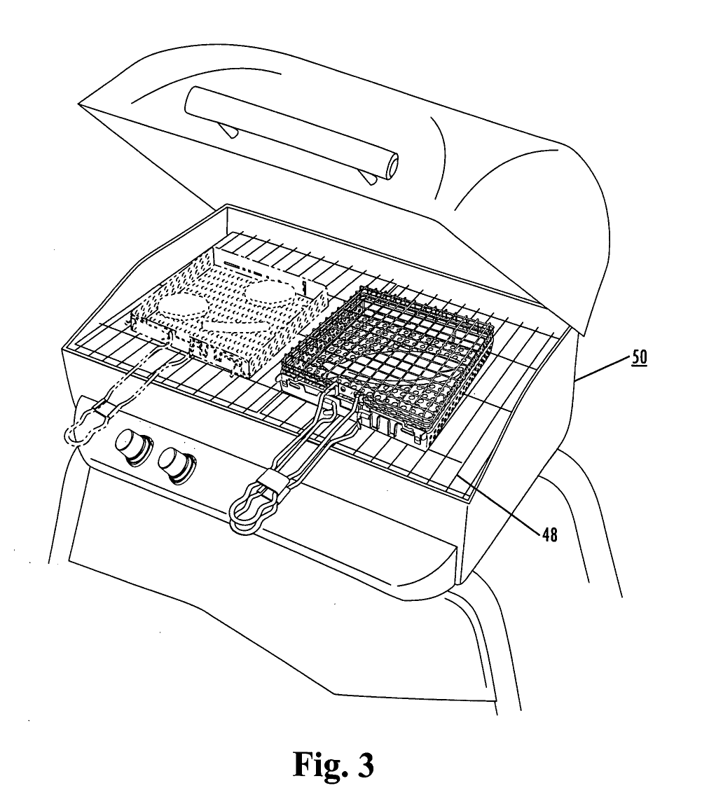

Referring now to FIG. 3, the present combination cooking basket and tool holder is shown deployed on the cooking surface or grate 48 of a barbecue grill 50. The unit on the left side of the cooking grate is shown with the cooking tools removed and the upper and lower baskets secured together for use in cooking. In this configuration, the upper and lower baskets are secured together and can be flipped over to cook the food therein on both sides, or can be used to shake the food so as to cause it to rotate or flip over. The unit illustrated in phantom lines on the left side of the cooking grate in FIG. 3 is illustrated with just one of the baskets, and can be used for cooking items of food and confining the items to a certain area of the cooking grate. It will be understood that either the upper or lower basket can be used singularly in the manner shown in FIG. 3 depending on the items being cooked, the preferences of the chef, etc. This provides the chef with a great deal of versatility and cooking options for a variety of foods. It can also be appreciated from these illustrations that the baskets could easily be used over an open campfire or in an indoor oven.

After the food has been prepared, it is removed from the basket or baskets, and the tools are returned to the lower basket as shown in FIG. 2A. The upper basket is placed over the lower basket and secured to assume the position illustrated in FIG. 1. The entire unit can now be placed into a sink for soaking, or directly into dishwasher where the entire unit can be cleaned and readied for subsequent use.

While an embodiment and modifications thereof of a combination cooking basket and tool holder have been shown and described in detail herein, various additional changes and modifications may be made without departing from the scope of the disclosure and the appended claims.

Therefore, having thus described the invention, at least the following is claimed:

1. A combination cooking basket and tool holder comprising at least one basket and at least one tool used in manipulating food items being cooked, the basket including fastening means for releasably holding the basket and tool together.

2. A combination cooking basket and tool holder as defined in claim 1 and further including a second basket mounted over said one basket and securable thereto for containing at least a portion of said tool therein.

3. A combination cooking basket and tool holder as defined in claim 2 and including a plurality of tools releasably secured in said basket.

4. A combination cooking basket and tool holder as defined in claim 1 and including a plurality of tools releasably secured in said basket.

5. A combination cooking basket and tool holder comprising a first basket and a second basket releasably secured together and forming an enclosure, and at least one tool used for manipulating food being cooked releasably secured in said enclosure.

6. A combination cooking basket and tool holder as defined in claim 5 and including a plurality of tools releasably secured in said enclosure.

7. A combination cooking basket and cooking tool holder comprising a lower basket having walls and an open top, an upper basket having walls and an open top, said upper basket being inverted and releasably securable to said lower basket for forming an enclosure therebetween, and at least one cooking tool having at least a portion thereof releasably secured in said enclosure.

8. A combination cooking basket and cooking tool holder as defined in claim 7 and including securing means for holding said upper and lower baskets together.

9. A combination cooking basket and tool holder as defined in claim 8 and including a plurality of tools releasably secured in said basket.

10. A combination cooking basket and tool holder as defined in claim 7 and including a plurality of tools releasably secured in said basket.
